(19) United States
(12) Patent Application Publication
(10) Pub. No.: US 2015/0212694 A1
(43) Pub. Date: Jul. 30, 2015

(54) INTERNET BROWSER ZOOMING

(71) Applicant: Yaoshiang Ho, San Francisco, CA (US)

(72) Inventor: Yaoshiang Ho, San Francisco, CA (US)

(73) Assignee: Google Inc., Mountain View, CA (US)

(21) Appl. No.: 13/462,761

(22) Filed: May 2, 2012

(51) Int. Cl. G06F 3/0484; G06F 3/0481; G06F 3/048; G06F 3/041

(52) U.S. Cl. CPC G06F 3/04842; G06F 3/04847; G06F 3/0481

(57) ABSTRACT

A computer-implemented method for increasing a size of content associated with a frame of a web page displayed in a web browser is provided. The method includes determining that the web page contains a plurality of frames, wherein each frame contains content comprising text or image data. The method further includes receiving an indication of selection of one of the plurality of frames and performing a zoom operation for content of the selected one of the plurality of frames. The method further refrains from performing the zoom operation for content of the frames other than the selected one of the plurality of frames.

### FIELD

The subject technology generally relates to internet browsing and, in particular, relates to increasing a size of text in a frame of a web page displayed in a web browser.

### BACKGROUND

An internet browser on a device, such as a mobile phone, portable computer, or computer, may be used to view a web page. The browser may provide for zooming, thereby allowing the user to increase the size of web page text, imagery, and/or embedded widgets (such as a flash video player) displayed within the browser.

### SUMMARY

The disclosed subject matter relates to a computer-implemented method for increasing a size of content associated with a frame of a web page displayed in a web browser. The method comprises determining that the web page comprises a plurality of frames, wherein each frame contains content comprising text or image data. The method further comprises receiving an indication of selection of one of the plurality of frames; and performing a zoom operation for content of the selected one of the plurality of frames. The method also comprises refraining from performing the zoom operation for content of the frames other than the selected one of the plurality of frames.

The disclosed subject matter further relates to a system for performing a zoom operation of a selected frame of a web page. The system comprises a detection module configured to determine that the web page comprises more than one frame, wherein each frame contains content comprising text data, image data, or widget data. The system also comprises a receiving module configured to receive a user input indicative of a selection of one of the frames. The system further comprises a zooming module configured to perform a zoom operation for content of the selected frames, and to refrain from performing the zoom operation for content of the non-selected frames.

The discloses subject matter also relates to a machine-readable medium encoded with executable instructions for performing a zoom operation of a selected frame of a web page. The instructions comprise code for determining that the web page comprises a plurality of frames based on web page data; receiving an indication of selection of one of the plurality of frames based on user input; performing a zoom operation for content of the selected one of the plurality of frames based on user input; and refraining from performing the zoom operation for content of the frames other than the selected one of the plurality of frames.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a system for performing a zoom operation of a selected frame of a web page.

FIG. 2 illustrates an example of a method for performing a zoom operation of a selected frame of a web page.

FIG. 3 is a flowchart illustrating another example of a method for performing a zoom operation of a selected frame of a web page.

FIG. 4 illustrates an example of a device having an internet browser.

FIG. 5 illustrates an example of a web page having a plurality of frames.

FIG. 6 illustrates an example of a conventional zoom operation on a web page having a plurality of frames.

FIG. 7 illustrates an example of a zoom operation for a selected frame, on a web page having a plurality of frames.

FIG. 8 is a block diagram illustrating components of a controller.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

An internet browser on a device, such as a mobile phone, portable computer, or computer, may be used to view a web page. The browser may provide for zooming, thereby allowing the user to increase the size of web page text, imagery, and/or embedded widgets (such as a flash video player) displayed within the browser

Zooming by the browser, however, typically does not take into account the relative importance of the text, images, and/or widgets (e.g., an embedded flash player) of the web page. For example, a particular web page may contain two or more frames, with one frame containing the main content (such as story headlines and summaries) and the other frame containing periphery content (such as related content or unrelated content). The user may be more interested in zooming or increasing the size of the main content displayed on the browser and less interested in zooming in on the periphery or secondary content.

The browser, however, is not capable of zooming only a portion or frame of a web page. Rather, zooming causes the entire web page, including all the displayed frames from the web page, to increase the size of the text and/or images contained therein. With a display size that is typically fixed due to a display area of the monitor or screen of the device, the text is then formatted to fit within its respective frame through a process referred to as “re-flow.” In certain instances, a width of a frame may be increased due to the zooming, thereby causing a width of an adjacent frame to be reduced. Accordingly, if the width of the frame containing the periphery content is increased, the width of the frame containing the main content is reduced.

According to various aspects of the subject technology, an internet browser application for allowing a user to select a specific frame or panel in a web page and to perform a zoom operation only on the selected frame, is provided. The browser performs the zoom operation on the selected frame and causes the text and/or image data in the selected frame to be increased without affecting the size of text or image data in any non-selected frame.

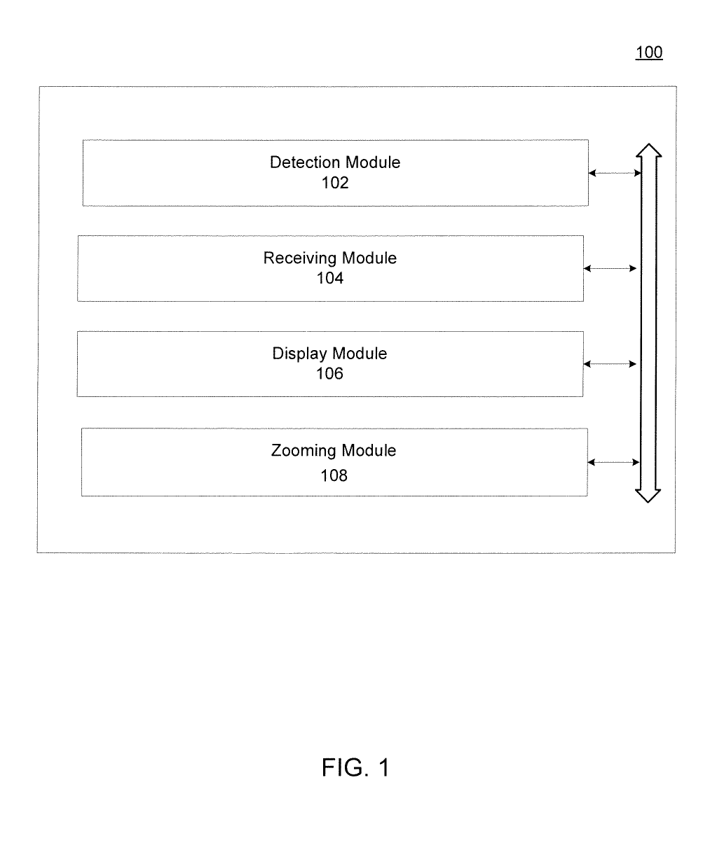

FIG. 1 illustrates an example of a system 100 for performing a zoom operation of a selected frame of a web page. System 100 comprises a detection module 102, a receiving module 104, a display module 106, and a zooming module 108. These modules may be in communication with one another. The modules may be implemented in software (e.g., subroutines and code). Some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

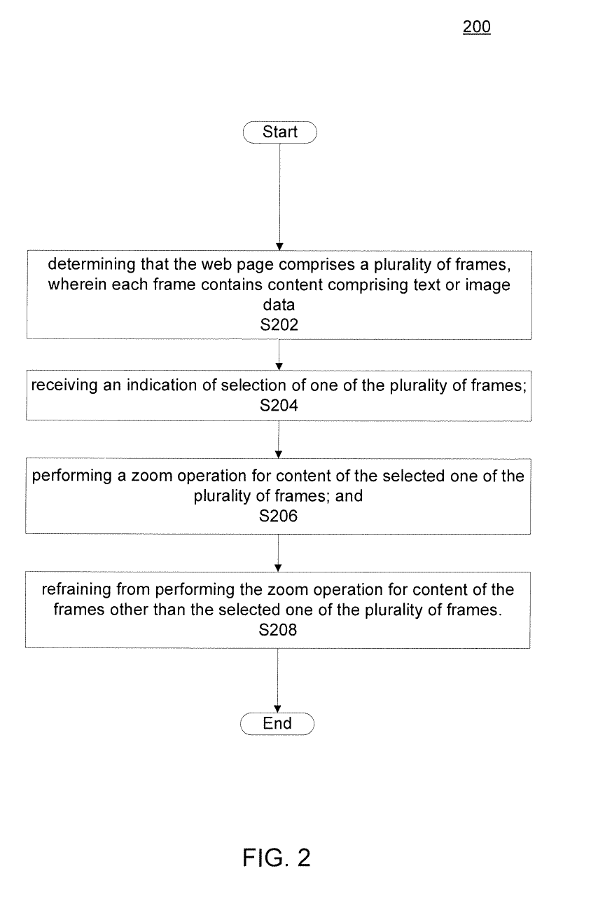

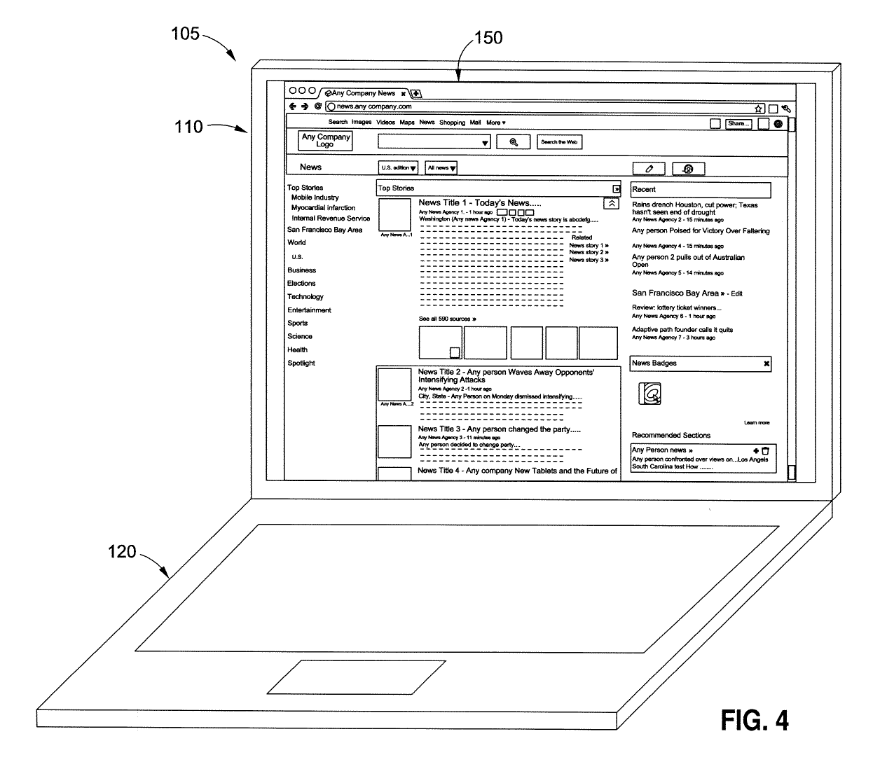

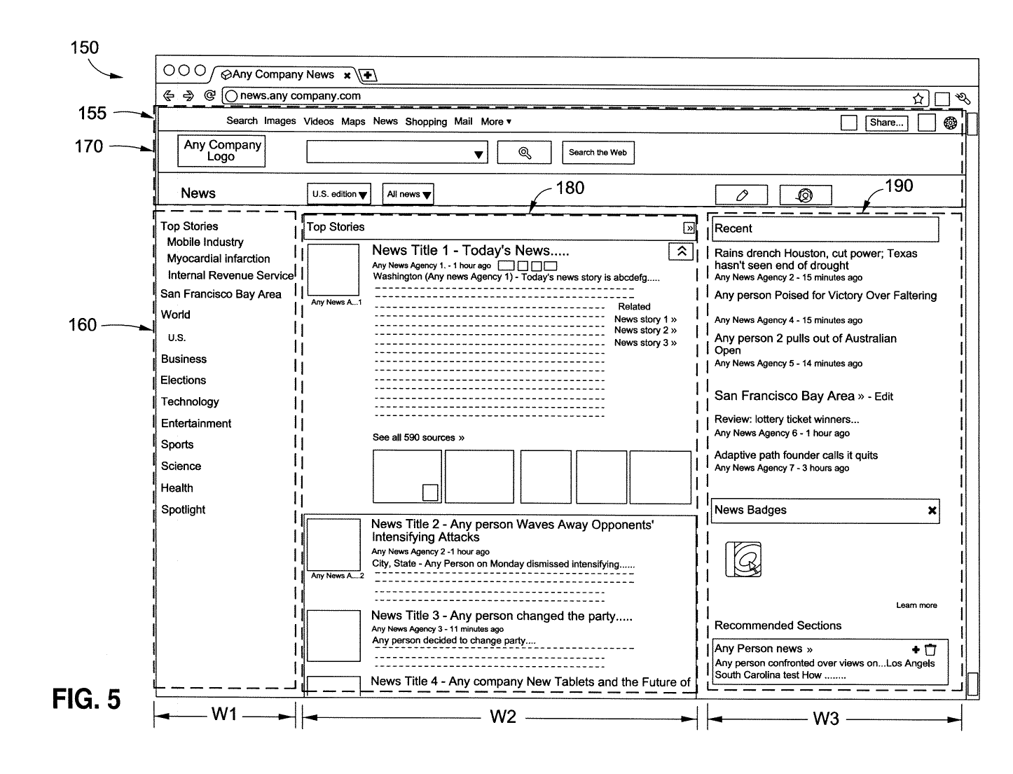

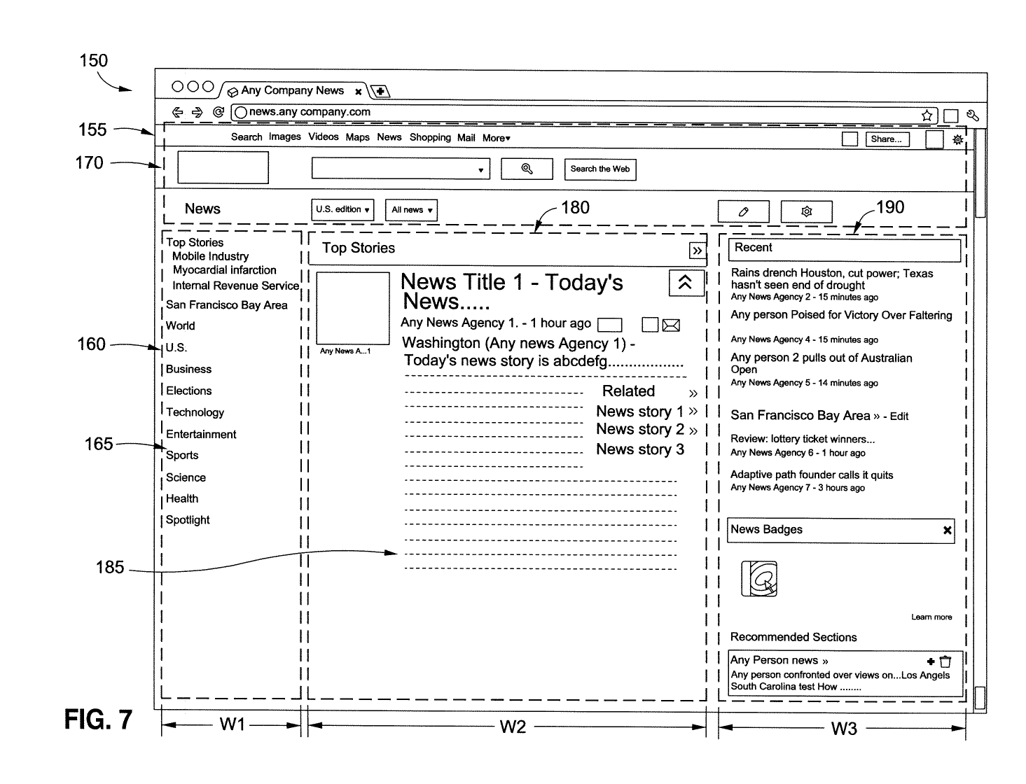

FIG. 2 illustrates an example of a method 200 for performing a zoom operation of a selected frame of a web page. Method 200 will be described with reference to the system of FIG. 1, together with examples of a device in FIG. 4 and web pages of FIGS. 5 and 7. However, it should be noted that method 200 is not limited to such systems/configurations and web pages, and that other systems/configurations and web pages can be used instead.

In this regard, FIGS. 4, 5, and 7 illustrate an example of device 105 having an internet browser application 150. The browser 150 may be a software application configured to view a web page 155 on the device 105. As shown in FIG. 4, the device 105 may be a laptop or portable computer. However, the device 105 may be any suitable device with a display 110 and data input 120. The data input 120 may be a keyboard, track-pad, mouse, touch-sensitive display, and/or other devices configured for data input.

According to step S202 in FIG. 2, the detection module 102 may determine that a web page 155 comprises a plurality of frames, wherein each frame contains content comprising text or image data. As shown in FIG. 5, the browser 150 may display a web page 155 having a plurality of frames on the display 110 of the device 105. The plurality of frames may comprise a top frame 170, a left frame 160, a middle frame 180, and a right frame 190. The plurality of frames, 160, 170, 180, and 190, may include content comprising text data, image data, and/or embedded widgets (such as a flash video player). For example, the top frame 170 may include a company logo, search box, and user information. The left frame 160 may include a list of links to content on another web page. The right frame 190 may include sponsored information or recommendations based on a particular search. The middle frame 180 may contain news headlines, videos, and articles. In this example, the middle frame 180 may contain the main content (such as a particular news article), while the top frame 170, left frame 160, and right frame 190, may contain periphery content (such as related content or unrelated content). The left frame 160 may have a width W1. The middle frame 180 may have a width W2. The right frame 190 may have a width W3. The width W2 of the middle frame 180 may be larger than the width W3 of the right frame 190. The width W3 of the right frame 190 may be larger than the width W1 of the left frame 170.

The detection module 102 may determine whether the web page 155 comprises a plurality of frames based on code of the web page or web page data. For example, the detection module 102 may be configured to detect whether the code or data contains one or more commands pertaining to the display of more than one frame. If the detection module 102 determines that the web page 155 comprises more than one frame, then the detection module 102 may enable a “select a frame to zoom” mode, as discussed further below. If, however, the detection module 102 determines that the web page 155 does not comprise more than one frame, then the detection module 102 may disable the “select a frame to zoom” mode and any zoom operation performed thereafter, will cause the entire web page 155 to be zoomed. In example aspects, the browser 150 itself may be configured to identify whether the web page 155 includes one or more frames based on received web page data or code.

If the detection module 104 enables the “select a frame to zoom” mode, then user input may be received from the user of the device 105 to activate the “select a frame to zoom” mode. The “select a frame to zoom” mode may be activated by receiving from the user, a mouse-based input, a touch-based input, a button-based input, a keyboard-based input, or other suitable user input via an interface (e.g., a graphical user interface (GUI) associated with a web browser). This user input may indicate that the user wishes to activate the “select a frame to zoom” mode and perform a zoom operation on a particular frame of interest. For example, the user input may comprise the pressing and holding of a predetermined key on a keyboard 120, such as the <Command> key. In this regard, the receiving module 104 may monitor the device 105 for the user input and may activate the “select a frame to zoom” mode upon receiving the user input.

According to step S204, an indication of a selection of one of the plurality of frames may be received from the user of the device 105 by the receiving module 104. As discussed above, the user may be interested in performing a zoom operation to increase a size of content displayed in a particular frame of interest displayed on the browser 150, and less interested in performing a zoom operation on content displayed in other frames on the browser 150. The indication of selection of one of the plurality of frames by the user may, for example, comprise a mouse-based input, a touch-based input, a button-based input, a keyboard-based input, or other suitable user input. For example, the indication of a selection may comprise a mouse-based input relating to a position of a cursor or indicator on the display 110 relative to the plurality of frames. As the user positions the mouse cursor over one of the plurality of frames, the receiving module 104 receives the indication of selection, which in this example, comprises the frame that is located under the mouse cursor. That is, the selected frame is the frame that the mouse cursor is hovering over. If the user positions the mouse cursor over another frame, then the selected frame is the frame that is then located under the mouse cursor. This user input may indicate that the user wishes to perform the zoom operation on the selected one of the plurality of frames. In this regard, the receiving module 104 may monitor the device 105 for the indication of selection by the user.

In example aspects, the display module 106 may provide for differentiated display of the selected one of the plurality of frames. For example, if the indication of a selection comprises a mouse-based input relating to a position of a cursor or indicator, as described above, then the display module 106 may be configured to display a border surrounding the frame located under the mouse cursor, the selected frame. The display module 106 may differentiate the display of the selected frame by highlighting the frame, changing a color of the frame, or by otherwise denoting the selected frame to the user. By differentiating the display of the selected frame, the display module 106 may aid the user in ascertaining which one of the plurality of frames is the currently selected frame.

According to step S206 in FIG. 2, the zooming module 108 may perform a zoom operation for content of the selected one of the plurality of frames. The zooming module 108 may perform the zooming operation based on user input which may, for example, comprise a mouse-based input, a touch-based input, a button-based input, a keyboard-based input, or other suitable user input. This user input may indicate that the user wishes to perform the zoom operation on the selected frame. For example, the user input may comprise the pressing of a predetermined key on the keyboard 120, such as the <+> key. In another example, the user input may comprise scrolling a mouse wheel. In yet another example, the user input may comprise using finger gestures or button inputs to interact with the frames displayed on the web page 155. In this regard, the zooming module 108 may monitor the device 105 for the user input and may perform the zoom operation upon receiving the user input.

In example aspects, the browser 150 itself may be configured to perform the zoom operation for content of the selected one of the plurality of frames. In another example, a plug-in may be configured to perform the zoom operation.

According to step S208 in FIG. 2, the zooming module 108 may be configured to only perform the zoom operation for content of the selected frame, while refraining from performing the zoom operation for content of the non-selected frames (i.e., the frames other than the selected one of the plurality of frames). For example, referring to FIGS. 5 and 7, the web page 155 may include a plurality of frames comprising the top frame 170, the left frame 160, the middle frame 180, and the right frame 190. The plurality of frames, 160, 170, 180, and 190, may include content comprising text data, image data, and/or embedded widgets (such as a flash video player). The top frame 170, the left frame 160, and the right frame 190 include periphery content (such as related content or unrelated content), while the middle frame 180 contains the main content (such as a particular news article).

In this example, the user may wish to perform the zoom operation only on the middle frame 180 because it contains the main content. Referring to FIG. 7, after the receiving module 104 receives the indication of selection comprising the middle frame 180, the zooming module 108 performs the zoom operation on only the middle frame 180. Accordingly, the zooming module 108 may increase the size of the text or image data of the middle frame 180 displayed in the browser 150, without altering the size of text or image data in any non-selected frames 160, 170, and 190, displayed in the browser 150. The display of text 185 of the middle frame 180 is thus larger than the display of text 165 of the non-selected frames 160, 170, and 190.

In some aspects, the zooming module 108 may perform the zoom operation without altering the width of each frame. As discussed above, each frame has a width. In this example, the left frame 160 has a width W1, the middle frame 180 may has a width W2, the right frame 190 has a width W3. The width W2 of the middle frame 180 is larger than the width W3 of the right frame 190. The width W3 of the right frame 190 is larger than the width W1 of the left frame 170. Referring to FIGS. 5 and 7, the respective width of each frame remains unchanged and is maintained before and after the zoom operation is performed. That is, the width of the frames 160, 180, and 190 before and after the zoom operation are the same, W1, W2, and W3, respectively.

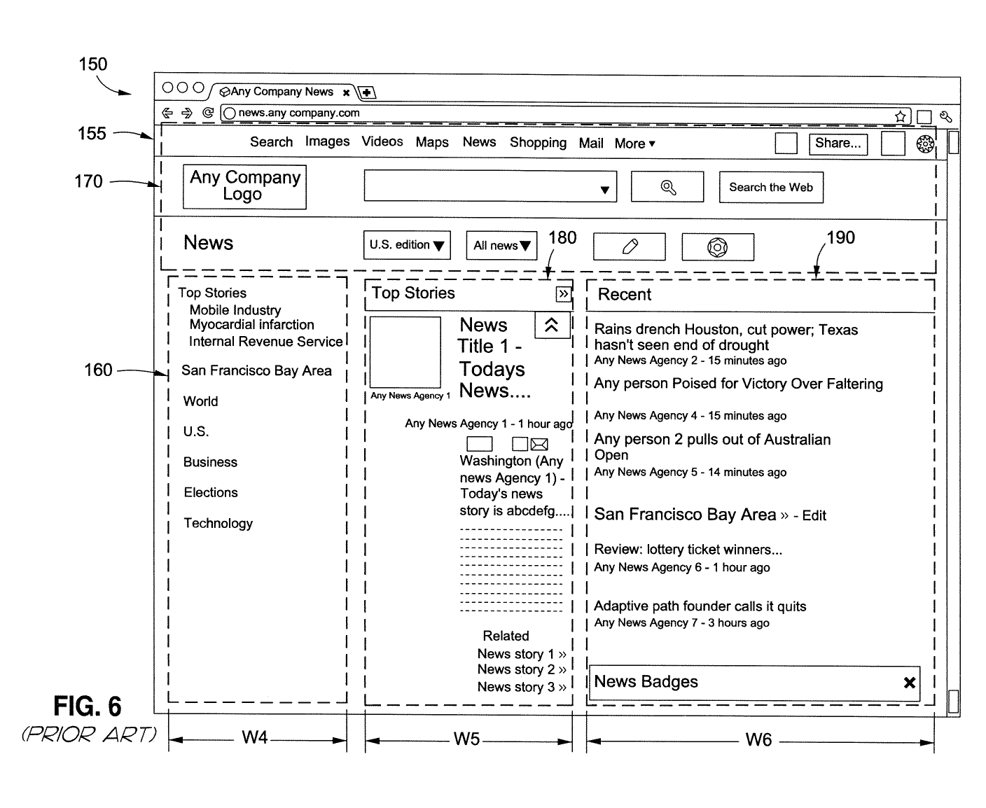

In contrast, referring to FIG. 6, the conventional zoom operation causes the size of text or image data in all the frames to be increased. In addition, the conventional zoom operation causes the width of each frame to change. For example, the width W5 of the middle frame 180, containing the main content, is reduced, while the widths, W4 and W6, of the left frame 160 and the right frame 190, respectively, are increased. The reduced width W5 of the middle frame 180 may make it difficult for the user to read the content in the middle frame 180.

The zooming module 108 may also perform the zoom operation to reduce the size of content of the selected frame. The zooming module 108 may perform the zooming operation based on user input which may, for example, comprise a mouse-based input, a touch-based input, a button-based input, a keyboard-based input, or other suitable user input. This user input may indicate that the user wishes to perform the zoom operation on the selected frame. For example, the user input may comprise the pressing of a predetermined key on the keyboard 120, such as the <−> key. In another example, the user input may comprise scrolling a mouse wheel. In yet another example, the user input may comprise using finger gestures or button inputs to interact with the frames displayed on the web page 155. In this regard, the zooming module 108 may monitor the device 105 for the user input and may perform the zoom operation upon receiving the user input.

The zooming module 108 may also reset the size of content of the selected frame. The zooming module 108 may reset the size of content of the selected frame based on user input which may, for example, comprise a mouse-based input, a touch-based input, a button-based input, a keyboard-based input, or other suitable user input. This user input may indicate that the user wishes to reset the size of content of the selected frame. For example, the user input may comprise the pressing of a predetermined key on the keyboard 120, such as the <0> key. In another example, the user input may comprise scrolling a mouse wheel. In yet another example, the user input may comprise using finger gestures or button inputs to interact with the frames displayed on the web page 155. In this regard, the zooming module 108 may monitor the device 105 for the user input and may reset the size of content of the selected frame upon receiving the user input.

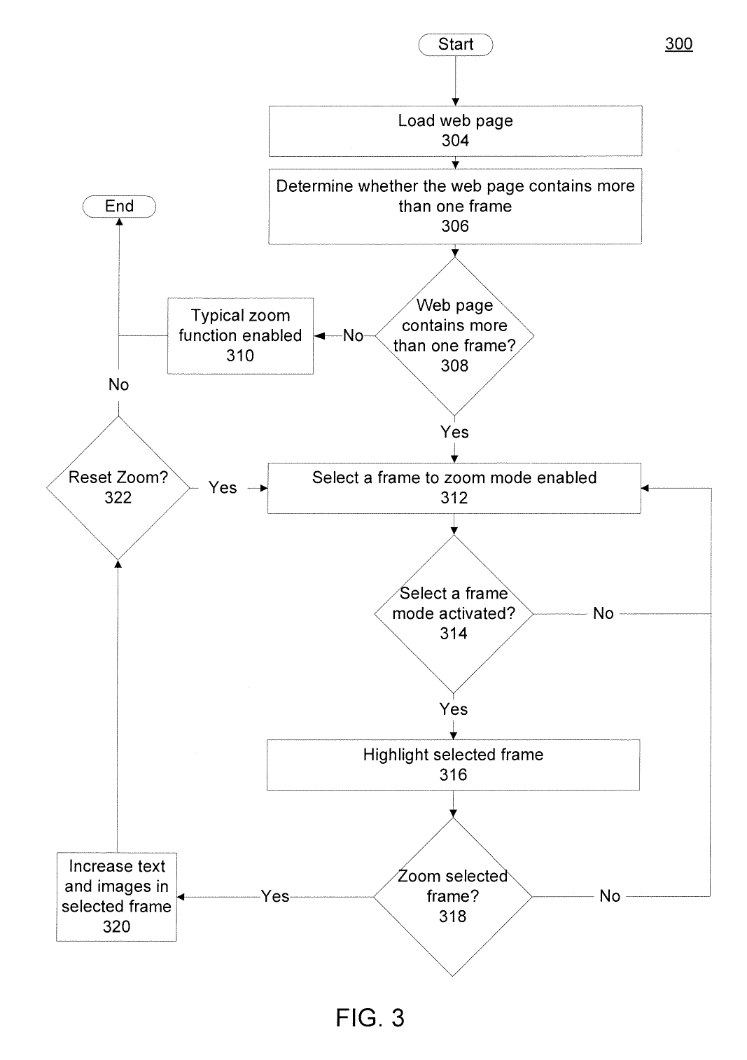

FIG. 3 is a flowchart illustrating another example of a method 300 for performing a zoom operation of a selected frame of a web page (e.g., web page 155). According to 304 and 306, the method 300 loads a web page (e.g., web page 155) and determines whether the web page contains more than one frame. According to 308 and 310, if the web page does not contain more than one frame, then the method 300 uses the conventional zoom operation. In the conventional zoom operation, the entire web page is affected by the zoom operation. According to 308 and 312, if the web page contains more than one frame, then the “select a frame to zoom” mode is enabled. According to 312 and 314, the method 300 monitors whether the user activates the “select a frame to zoom” mode. The “select a frame to zoom” mode may be activated by user input, which may comprise the pressing holding of a predetermined key on a keyboard (e.g., keyboard 120). According to 314 and 316, if the “select a frame to zoom” mode is activated, then the currently selected frame is highlighted. According to 316 and 318, the method 300 monitors whether the user wishes to perform the zoom operation on the selected frame. The zoom operation may be performed based on user input, such as the pressing of a predetermined key on the keyboard. According to 318 and 320, if the zoom operation is performed on the selected frame, then the size of image or text data in the selected frame are increased. According to 318 and 312, if the zoom operation is not performed, then the size of text or image data is not increased. According to 322, the size of image or text data may be reset based on user input, which may for example, comprise a predetermined key on the keyboard 120.

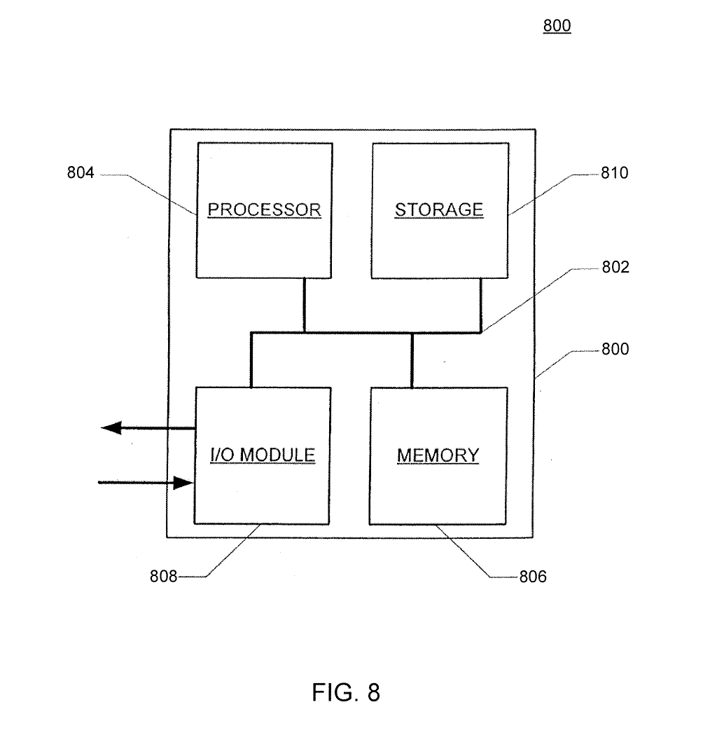

FIG. 8 is a block diagram illustrating components of a controller 800. Controller 800 comprises processor module 804, storage module 810, input/output (I/O) module 808, memory module 806, and bus 802. Bus 802 may be any suitable communication mechanism for communicating information. Processor module 804, storage module 810, I/O module 808, and memory module 806 are coupled with bus 802 for communicating information between any of the modules of controller 800 and/or information between any module of controller 800 and a device external to controller 800. For example, information communicated between any of the modules of controller 800 may include instructions and/or data. In some aspects, bus 802 may be a universal serial bus. In some aspects, bus 802 may provide Ethernet connectivity.

In some aspects, processor module 804 may comprise one or more processors, where each processor may perform different functions or execute different instructions and/or processes. For example, one or more processors may execute instructions for performing a zoom operation for content of a selected frame of a web page (e.g., method 200), and one or more processors may execute instructions for input/output functions.

Memory module 806 may be random access memory (“RAM”) or other dynamic storage devices for storing information and instructions to be executed by processor module 804. Memory module 806 may also be used for storing temporary variables or other intermediate information during execution of instructions by processor 804. In some aspects, memory module 806 may comprise battery-powered static RAM, which stores information without requiring power to maintain the stored information. Storage module 810 may be a magnetic disk or optical disk and may also store information and instructions. In some aspects, storage module 810 may comprise hard disk storage or electronic memory storage (e.g., flash memory). In some aspects, memory module 806 and storage module 810 are both a machine-readable medium.

Controller 800 is coupled via I/O module 808 to a user interface for providing information to and receiving information from an operator of system 100. For example, the user interface may be a cathode ray tube (“CRT”) or LCD monitor for displaying information to an operator. The user interface may also include, for example, a keyboard or a mouse coupled to controller 800 via I/O module 808 for communicating information and command selections to processor module 804.

According to various aspects of the subject disclosure, methods described herein are executed by controller 800. Specifically, processor module 804 executes one or more sequences of instructions contained in memory module 806 and/or storage module 810. In one example, instructions may be read into memory module 806 from another machine-readable medium, such as storage module 810. In another example, instructions may be read directly into memory module 806 from I/O module 808, for example from an operator of system 100 via the user interface. Execution of the sequences of instructions contained in memory module 806 and/or storage module 810 causes processor module 804 to perform a zoom operation of a selected frame of a web page. For example, a computational algorithm for increasing a size of text or image data in the selected frame may be stored in memory module 806 and/or storage module 810 as one or more sequences of instructions. Information such as the number of frames of a web page, the width of each respective frame in a web page, the size of text or image data in each respective frame of a web page, the user input, and/or other suitable information may be communicated from processor module 804 to memory module 806 and/or storage module 810 via bus 802 for storage. In some aspects, the information may be communicated from processor module 804, memory module 806, and/or storage module 810 to I/O module 808 via bus 802. The information may then be communicated from I/O module 808 to an operator of system 100 via the user interface.

One or more processors in a multi-processing arrangement may also be employed to execute the sequences of instructions contained in memory module 806 and/or storage module 810. In some aspects, hard-wired circuitry may be used in place of or in combination with software instructions to implement various aspects of the subject disclosure. Thus, aspects of the subject disclosure are not limited to any specific combination of hardware circuitry and software.

The term “machine-readable medium,” or “computer-readable medium,” as used herein, refers to any medium that participates in providing instructions to processor module 804 for execution. Such a medium may take many forms, including, but not limited to, non-volatile media and volatile media. Non-volatile media include, for example, optical or magnetic disks, such as storage module 810. Volatile media include dynamic memory, such as memory module 806. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “upper,” “bottom,” “lower,” “right,” “left,” “up,” “down,” “forward,” “backward,” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology.

1. A computer-implemented method for increasing a size of content associated with a frame of a web page displayed in a web browser, the method comprising:
determining that the web page comprises a plurality of frames;
receiving an indication of selection of one of the plurality of frames;
performing a zoom operation for content of the selected one of the plurality of frames while maintaining a respective width of each of the plurality of frames; and
refraining from performing the zoom operation for content of the frames other than the selected one of the plurality of frames.

2. The method of claim 1, wherein the indication of selection is based on a position of a cursor.

3. The method of claim 1, wherein the indication of selection is based on a gesture of a user.

4. The method of claim 1, wherein each frame contains content comprising text data, image data, or widget data and wherein the performing the zoom operation comprises increasing a size of the text data, image data, or widget data for the selected one of the plurality of frames.

5. The method of claim 1, wherein the plurality of frames each have a respective width and performing the zoom operation comprises maintaining the width of each frame.

6. The method of claim 1, further comprising providing for differentiated display of the selected one of the plurality of frames.

7. The method of claim 6, wherein the providing for differentiated display comprises displaying a border surrounding the selected one of the plurality of frames.

8. A system for performing a zoom operation of a selected frame of a web page, the system comprising:
one or more processors; and
a memory coupled to the one or more processors and configured with executable instructions stored thereon, the instructions when executed causing the one or more processors to:
determine that the web page comprises more than one frame, wherein each frame contains content comprising text data, image data, or widget data;
receive a user input indicative of a selection of one of the frames; and
perform a zoom operation for content of the selected frames while maintaining a respective width of each of the frames, and to refrain from performing the zoom operation for content of the non-selected frames.

9. The system of claim 8, wherein the user input comprises a mouse-based input.

10. The system of claim 8, wherein the user input comprises a gesture-based input.

11. The system of claim 8, wherein the instructions when executed further cause the computing device to increase a size of text data, image data, or widget data displayed in a web browser.

12. The system of claim 8, wherein instructions when executed further cause the computing device to provide for differentiated display of the selected one of the plurality of frames.

13. A non-transitory computer-readable medium encoded with executable instructions for performing a zoom operation of a selected frame of a web page, the instructions comprising code for:
determining that the web page comprises a plurality of frames based on web page data;
receiving an indication of selection of one of the plurality of frames based on user input;
performing a zoom operation for content of the selected one of the plurality of frames based on user input while maintaining a respective width of each of the plurality of frames; and
refraining from performing the zoom operation for content of the frames other than the selected one of the plurality of frames.

14. The non-transitory computer-readable medium of claim 13, wherein the indication of selection is based on a position of a cursor.

15. The non-transitory computer-readable medium of claim 13, wherein the indication of selection is based on a gesture of a user.

16. The non-transitory computer-readable medium of claim 13, wherein the determining that the web page comprises a plurality of frames based on web page data comprises determining whether the web page data contains one or more commands pertaining to the display of more than one frame.

17. The non-transitory computer-readable medium of claim 13, wherein the performing a zoom operation comprises increasing a size of text data, image data, or widget data associated with the selected one of the plurality of frames.

18. The non-transitory computer-readable medium of claim 13, wherein the plurality of frames each have a respective width and performing a zoom operation comprises maintaining the width of each frame.

19. The non-transitory computer-readable medium of claim 13, further comprising providing for differentiated display of the selected one of the plurality of frames.

20. The non-transitory computer-readable medium of claim 19, wherein the providing for differentiated display comprises displaying a border surrounding the selected one of the plurality of frames.
